(19) United States
(12) Patent Application Publication
(10) Pub. No.: US 2011/0159955 A1
(43) Pub. Date: Jun. 30, 2011

(54) FLAT SCREEN GAME TERMINAL

(75) Inventors: Boris Itskov, Concord (CA); Genadi Peari, Concord (CA); Roman Brik, Concord (CA)

(73) Assignee: JVL CORPORATION, Concord, ON (CA)

(21) Appl. No.: 12/998,015

(22) PCT Filed: Sep. 9, 2009
(86) PCT No.: PCT/CA2009/001232

§ 371 Date: Mar. 9, 2011

(30) Foreign Application Priority Data
Sep. 9, 2008 (CA) 2,639,458

(51) Int. Cl. A63F 13/00; A63F 13/08

(52) U.S. Cl. 463/30; 463/46; 463/35

(57) ABSTRACT

A countertop entertainment terminal includes a terminal housing containing components for a pay to play game terminal including a stereo sound system. The sound system includes a pair of tweeter speakers adjacent an upper edge of the terminal housing and a pair of midrange speakers located on opposite sides of a touchscreen supported by the terminal housing. A sub-woofer speaker is provided within the housing and is open to a side of the housing. In a preferred embodiment the stereo sound system uses subassemblies for each of the tweeter speakers, the midrange speakers and the sub-woofer speaker, simplifying securement within or to the housing.

### FIELD OF THE INVENTION

The present application relates to countertop entertainment terminals, and in particular, such terminals for use in commercial establishments such as bars and restaurants.

### BACKGROUND OF THE INVENTION

Countertop entertainment terminals are known, and in particular, these terminals have been used for pay to play game terminals. The original game terminals were designed to withstand significant abuse, and the games played on such terminals were designed to be of a short duration and relatively simple to play. In more recent years, the sophistication of the games has increased and the terminals now may store in excess of 150 games for play. More recently, there has been some initiative to allow these game terminals to include at least payment and ordering capability associated with the pay to play of various music selections typically associated with a digital jukebox.

Game terminals are generally divided into countertop game terminals designed to be of a smaller size and sit on a counter or bar-type surface, and full-size game terminals which are self supporting structures having a large cabinet or pedestal and supported on a floor. With countertop terminals, the overall size of the terminal is restricted and the sound systems thereof are limited due to space limitations. Such countertop terminals have a relatively small footprint (i.e. occupy a small area on the support surface) and the terminals include both a coin box for collecting coin payments as well as a banknote cassette for storing received banknotes.

The game terminal of the present application has a number of advantages over existing countertop game terminals with respect to both the sound system provided with the countertop terminal and improved cooling air circulation provided through the terminal.

### SUMMARY OF THE INVENTION

A countertop entertainment terminal according to the present invention comprises a terminal housing containing therein a power supply, a CPU, a payment acceptor, a host of games stored in memory and accessible for play, and a stereo sound system; said housing supporting a touchscreen monitor to one side of said housing and having a game input control pad in front of and below said monitor. The housing supports two tweeter speakers adjacent an upper edge of the terminal housing and a pair of midrange speakers located on opposite sides of the housing and adjacent said monitor. The terminal further includes a woofer speaker interior to the terminal housing and associated with a speaker grating provided on a side of the terminal housing.

According to an aspect of the invention, the touchscreen monitor is pivotally secured to the terminal housing adjacent a bottom edge of the touchscreen for pivotal movement between an in-use position with the monitor closing a large service port in a front surface of the terminal housing to a service position opening the large service port to provide access to the interior of the terminal housing.

In a further aspect of the invention, the tweeter speakers are supported in a tweeter speaker subassembly. The tweeter speaker subassembly has one of the tweeter speakers supported at one end of the subassembly with the other tweeter speaker supported at an opposite end of the subassembly.

In a preferred aspect of the invention, the tweeter subassembly is mounted to an upper edge of the terminal housing and extends above and is generally parallel to the upper edge of the terminal housing.

According to an aspect of the invention, the midrange speakers are mounted in a midrange subassembly to position the midrange speakers either side of, and adjacent to, a lower edge of the touchscreen monitor. The midrange subassembly forms part of the terminal housing.

In a preferred aspect of the invention, the midrange subassembly includes a speaker housing for each midrange speaker with each speaker housing being removable from the subassembly if required for speaker repair or replacement.

In an aspect of the invention, the sub woofer speaker is secured in a sub woofer subassembly secured within the terminal housing.

### BRIEF DESCRIPTION OF THE DRAWINGS

Preferred embodiments of the invention are shown in the drawings, wherein:

FIG. 1 is a perspective view of the game terminal;

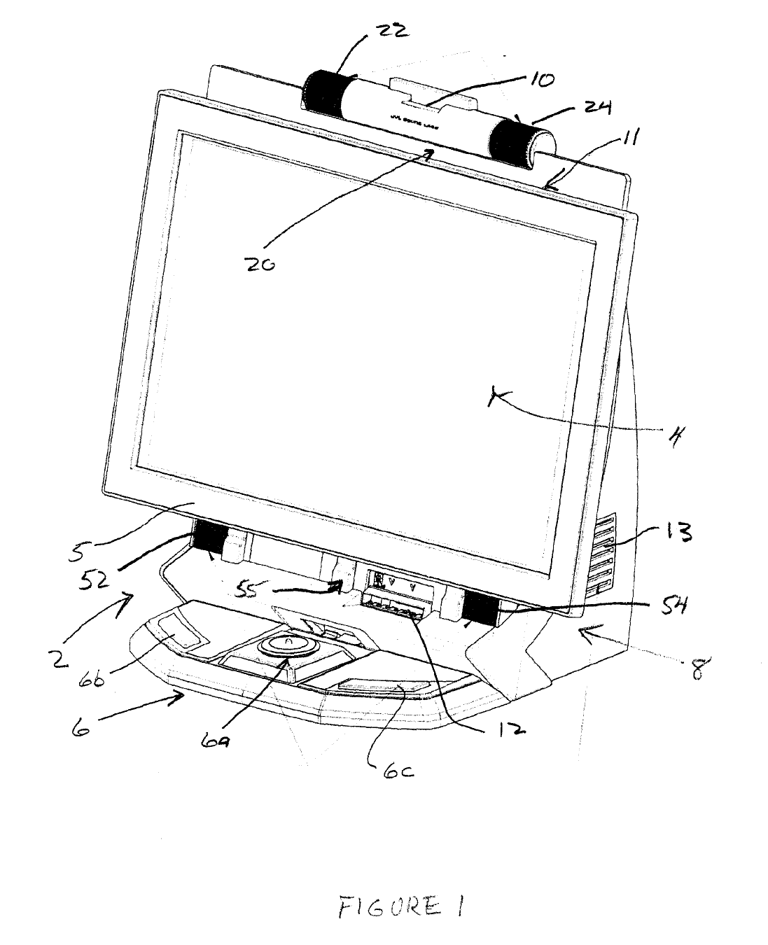

FIG. 2 is a perspective view similar to FIG. 1 with the touchscreen shown in a surface position allowing access to certain internal components;

FIG. 3 is a view similar to FIG. 2 showing additional cover elements provided within the game terminal;

FIG. 4 is a rear perspective view with both the coin box and banknote cassette removed, showing internal components of the game terminal;

FIG. 5 is a partial exploded perspective view of the game control input pad;

FIG. 6 is a perspective view of the game terminal in combination with a number of sub-assembly views showing the sound system components;

FIG. 7 is a perspective view of the rotatable base provided with the game terminal;

FIG. 8 is a rear perspective view showing both the coin box and banknote cassette used with the game terminal;

FIG. 9 is a perspective view of the coin box;

FIG. 10 is a rear perspective view showing the coin box and banknote cassette installed in the game terminal with a coin acceptor installed in the game terminal;

FIG. 11 is a view similar to FIG. 10 showing the coin acceptor about to be installed in the game terminal.

### DETAILED DESCRIPTION OF THE PREFERRED EMBODIMENTS

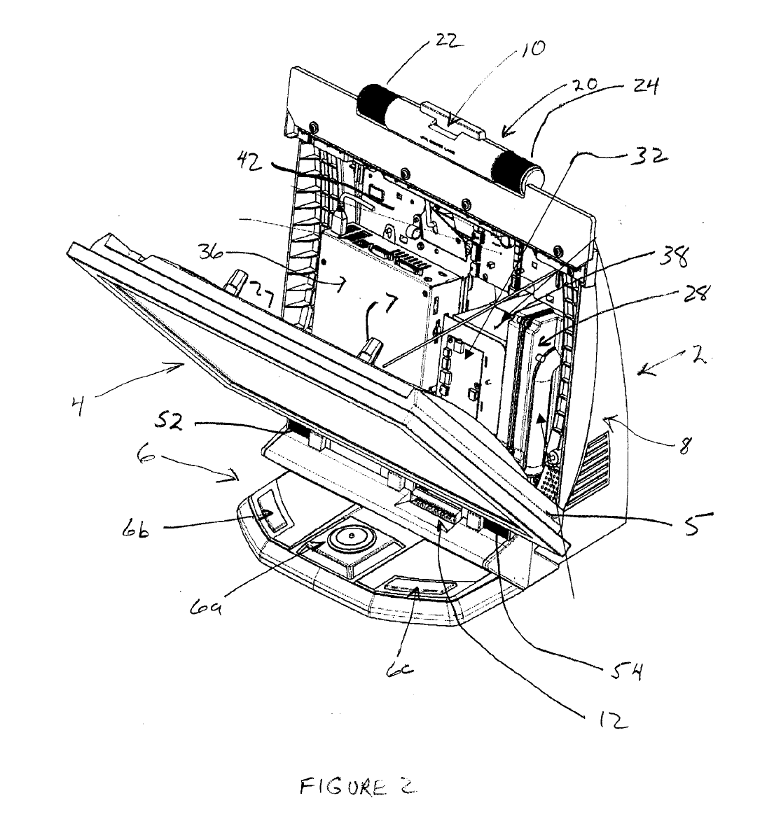

The entertainment terminal 2 includes a high definition touchscreen 4 that is pivotally secured adjacent a bottom edge 5 thereof to the support housing 8. The touchscreen includes a particular fastener arrangement 7 that is releasable from the rear of the terminal to allow the touchscreen 4 to move to the service position as generally shown in FIG. 2. A game control input pad 6 is provided at the base of the entertainment terminal, and allows a player to use both a joystick control generally shown as 6a or paddle controls indicated as 6b and 6c that are typically used for playing of the various games. Some of the games may only require use of the touchscreen 4 or use of the touchscreen in combination with input from the game control input pad 6 or use of the input pad 6 alone.

The terminal includes a banknote input slot 12 allowing the player to obtain various credits for playing of the game terminal, and includes a coin input slot generally shown as 10 on an upper surface 11 of the terminal 2.

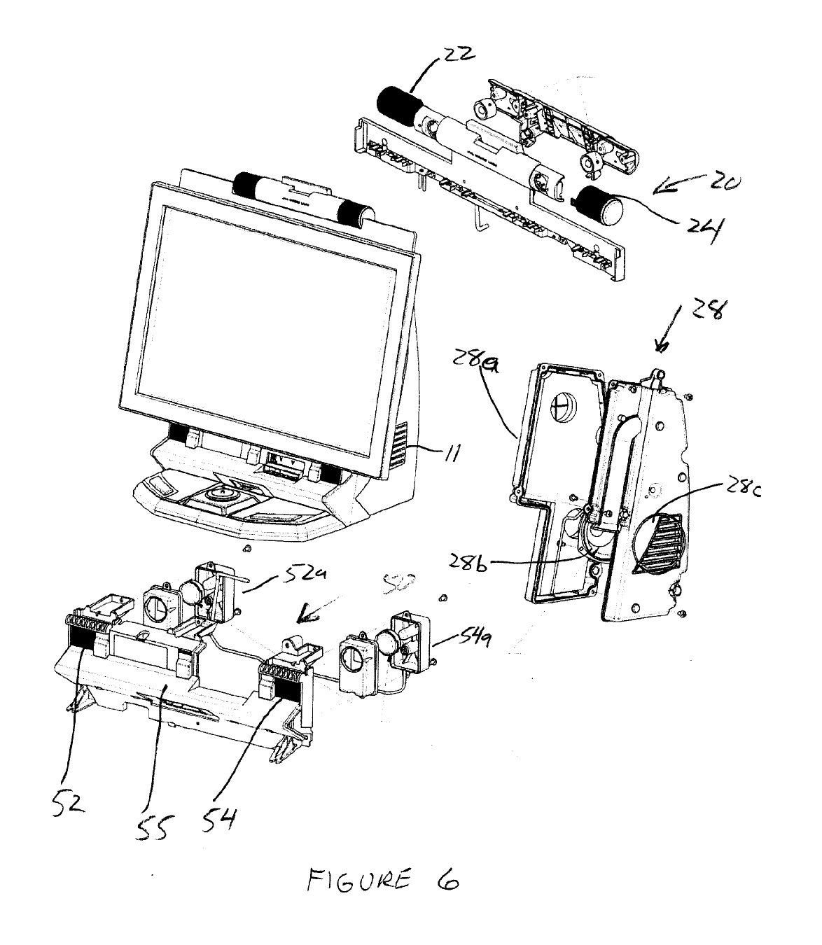

The game terminal includes a stereo sound system which in this case includes the tweeter assembly 20, a mid-range speaker assembly 50 (shown in FIG. 6) as well as the sub-woofer speaker assembly 28. As shown in FIG. 6, the tweeter sub-assembly includes tweeter speakers 22 and 24, and this sub-assembly can be completed and installed on the game terminal as generally shown in FIG. 6. Similarly, the mid-range sub-assembly 50 includes mid-range speakers 52 and 54, which are installed on the base portion 55. Each of the mid-range speakers 52 and 54 are provided in their own housing, generally indicated as 52a and 54a with these housings being installed on the base portion 55. With this arrangement, the individual speaker housings with the speakers enclosed therein can be provided on the base portion, and this simplifies installment of the mid-range speakers in the game terminal.

The sub-woofer sub-assembly 28 includes the housing 28a enclosing the sub-woofer speaker 28b. The actual housing 28 protects the sub-woofer speaker and again simplifies installment of the sub-woofer in the game terminal. The sub-woofer housing 28a includes an outlet port 28c for allowing the sound of the sub-woofer to pass out a side of the game terminal and through the grate generally shown as 13 in a side surface of the support housing 8.

The main purpose of the housing is to act as an acoustic suspension for the speaker. It has been designed as a tuned port enclosure to facilitate the best possible base frequencies acoustic response, utilizing the minimum available internal cabinet volume. The goal was to minimize the necessary cabinet footprint at the same time providing outstanding base response.

With the structures generally shown in FIG. 6, the sound system for the entertainment terminal 2 includes rich stereo sound associated with a 5 speaker stereo system including two tweeters, two mid-range speakers and a sub-woofer speaker.

In order to improve the sound associated with the game terminal, the terminal 2 includes an amplifier circuit board indicated as 32 in FIG. 2. It provides power amplification of the audio signal that is supplied to the five speaker sound system. With this particular structure, high quality sound is generated, improving both the capabilities of the entertainment terminal with respect to the sound quality associated with games, as well as the ability of the entertainment terminal to provide excellent sound output with respect to the playing of music recordings. This design also allows the terminal to be easily maintained should any of the components require placement. In this case, any of the sub-assemblies may be simply removed from the game terminal and a new sub-assembly installed.

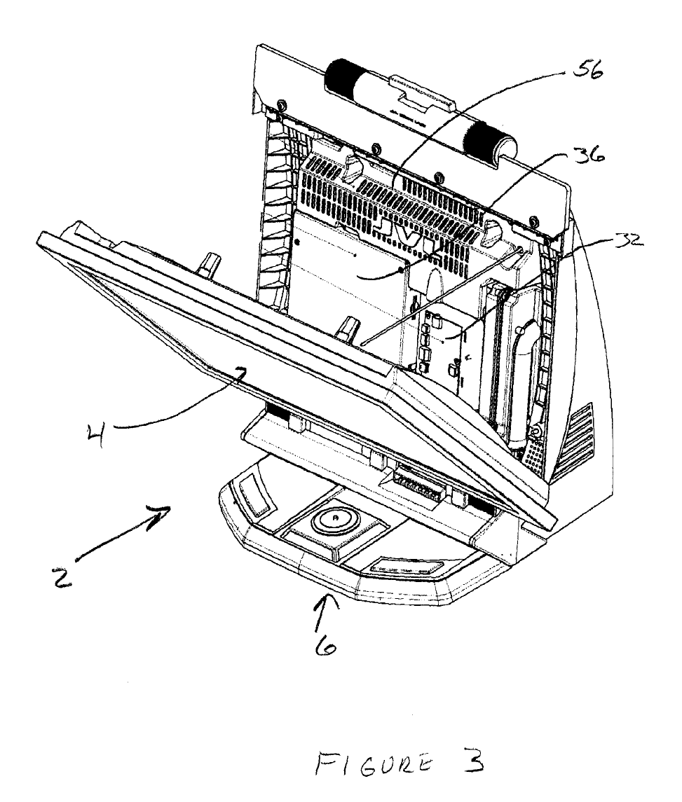

With the touchscreen monitor 4 in a pivoted forward service position, as shown in FIG. 3, certain components within the terminal can be serviced. This view also illustrates that the CPU sub-assembly 36 is accessible as well as the sound system amplifier 32. In this case, a wiring and I/O cover 56 is in place, and this is covering the I/O board 42 shown in FIG. 2 and various wiring that may be provided in the terminal. The I/O cover 56 is also a grated cover to allow for air circulation within the game terminal and cooling of the components behind cover 56.

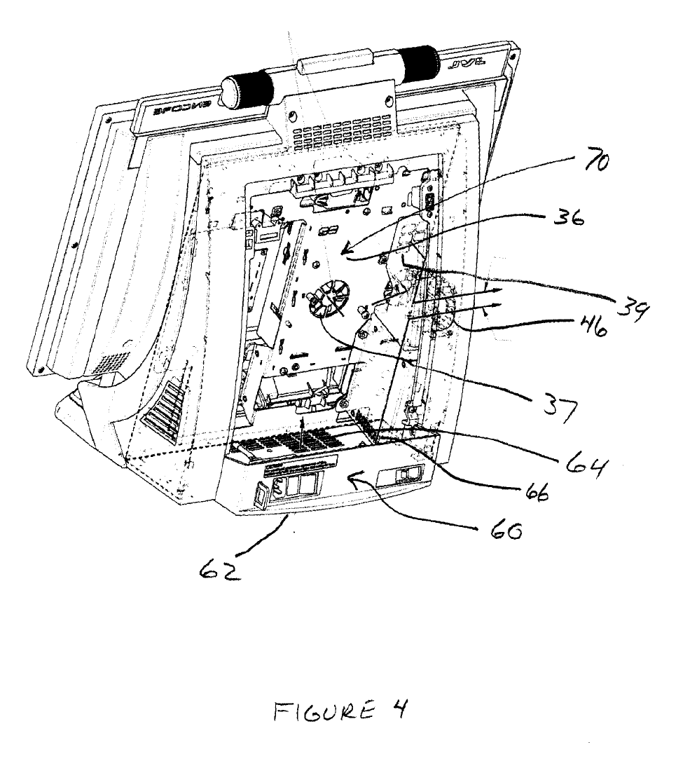

With game terminals, there are a number of electrical components which are sensitive to operating temperatures. These components are common to most computer systems, and primarily include the power supply and the CPU. As shown in FIG. 4, the CPU sub-assembly 36 includes a cooling fan 37 open on the back surface of the CPU for drawing air provided to the component chamber 70 through the fan of the CPU, with this air being discharged at the exhaust port 39. The exhaust port 39 is open to the housing 70 and the housing also includes its own exhaust port shown as 46. Thus, air is drawn in through the air intake 62 provided below the power supply 60, and this provides cooling air to the component chamber 70. The fan of the CPU then directs a portion of this air through the CPU for cooling thereof.

As shown in FIG. 4, air passes through the power supply 60 with a portion of this air exiting through the first output grate 64 for entry into the component chamber 70. A further portion of the air that is drawn in to the power supply passes through the power supply and exits through the second output grate shown as 66. Thus, a portion of the airflow is used to cool the power supply and a further portion of the air is provided to the component chamber. This provides an efficient cooling of the components within the entertainment terminal 2. The fans are partially enclosed to provide efficient cooling and at the same time reduce propagation of the fan noise. Utilizing oversized fans provides improved airflow at lower rotational speeds. This dramatically reduces the fan noise.

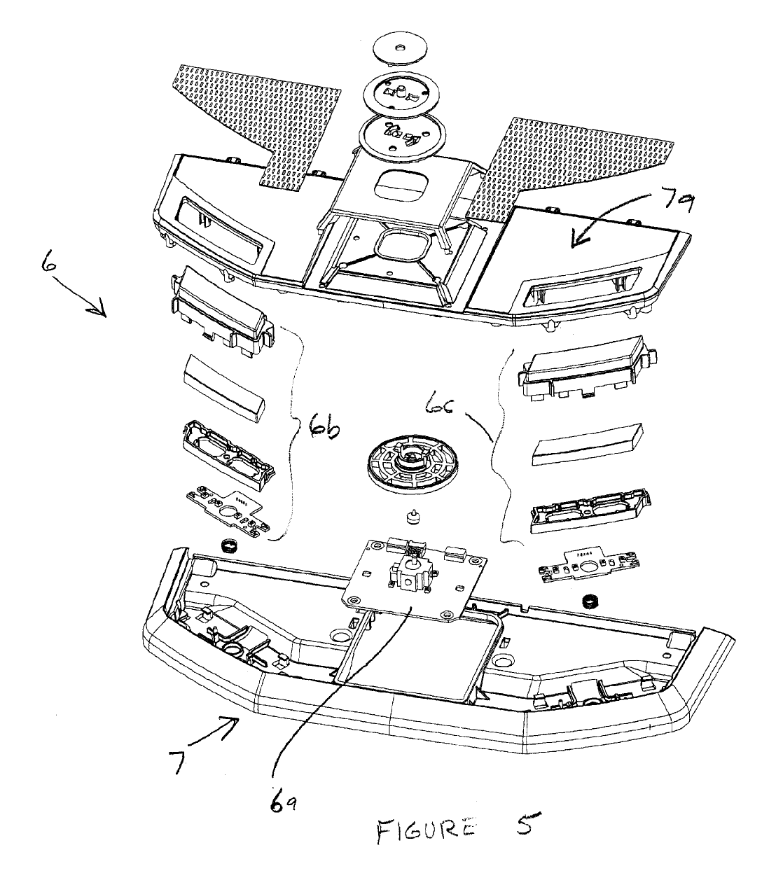

The exploded perspective view of FIG. 5 shows the game control input pad 6 having a molded plastic base portion that receives the joystick controller 6a and the paddle controllers 6b and 6c. A top cover 7a is also shown.

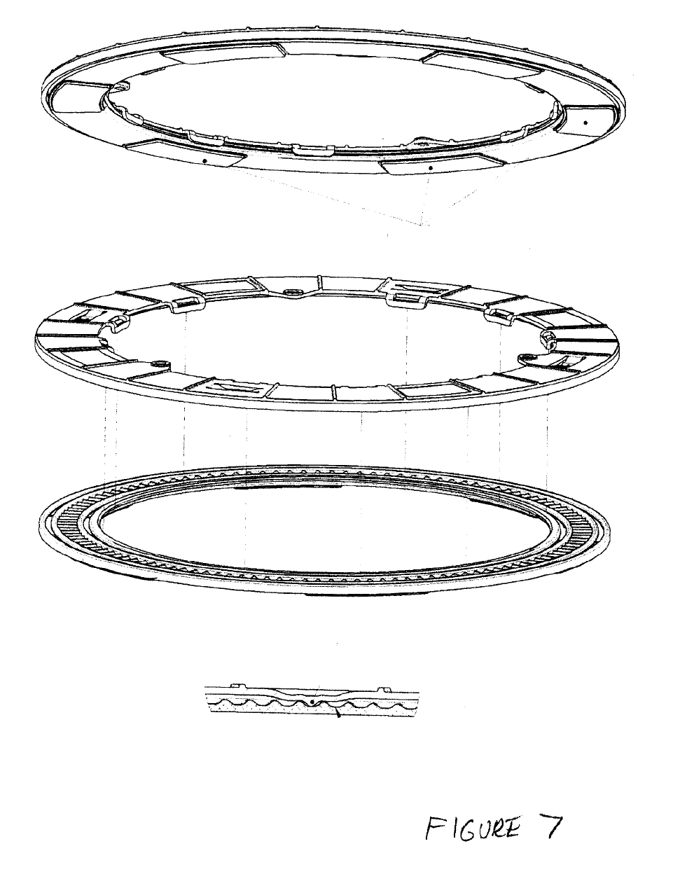

FIG. 7 shows details of the rotatable base of the game terminal.

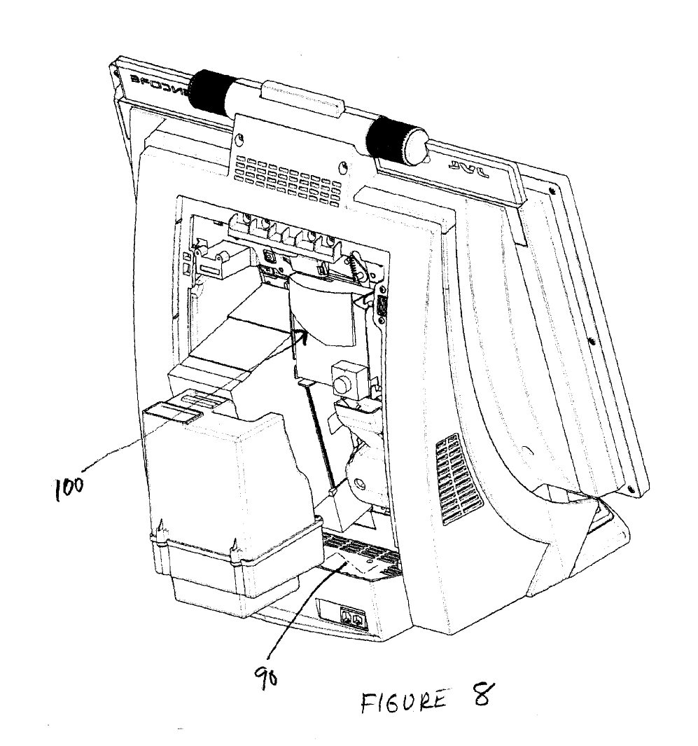

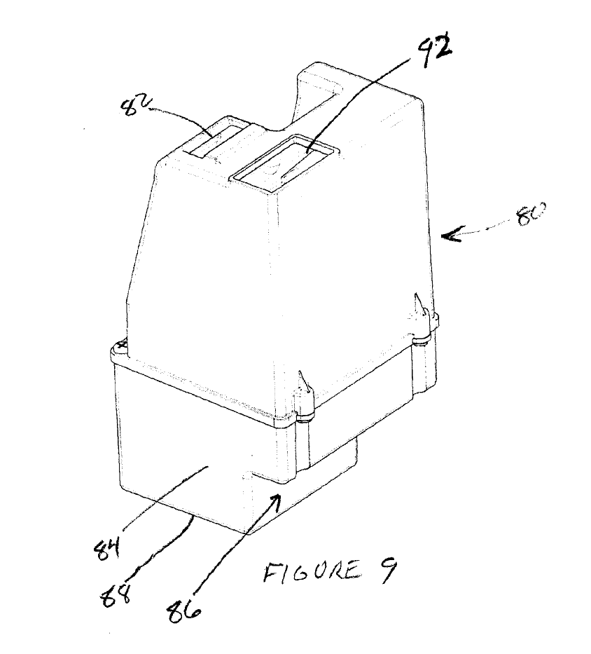

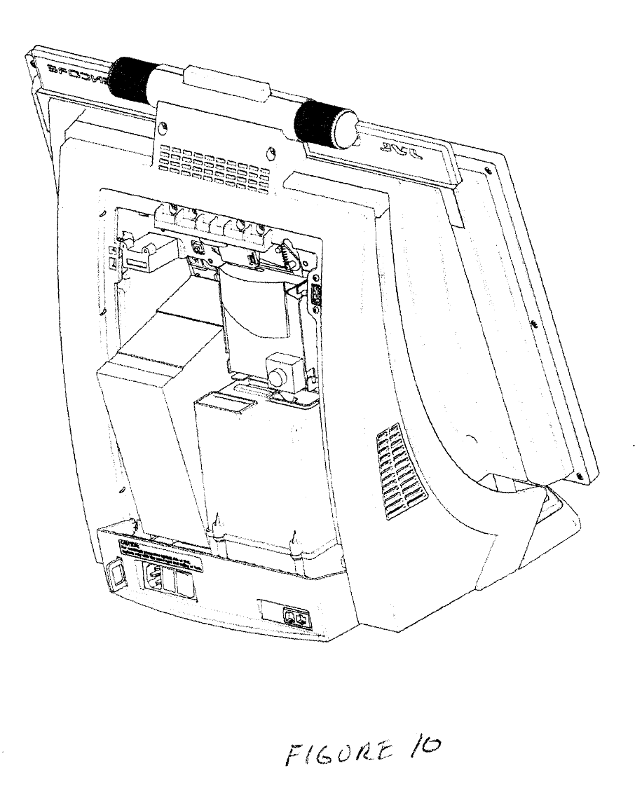

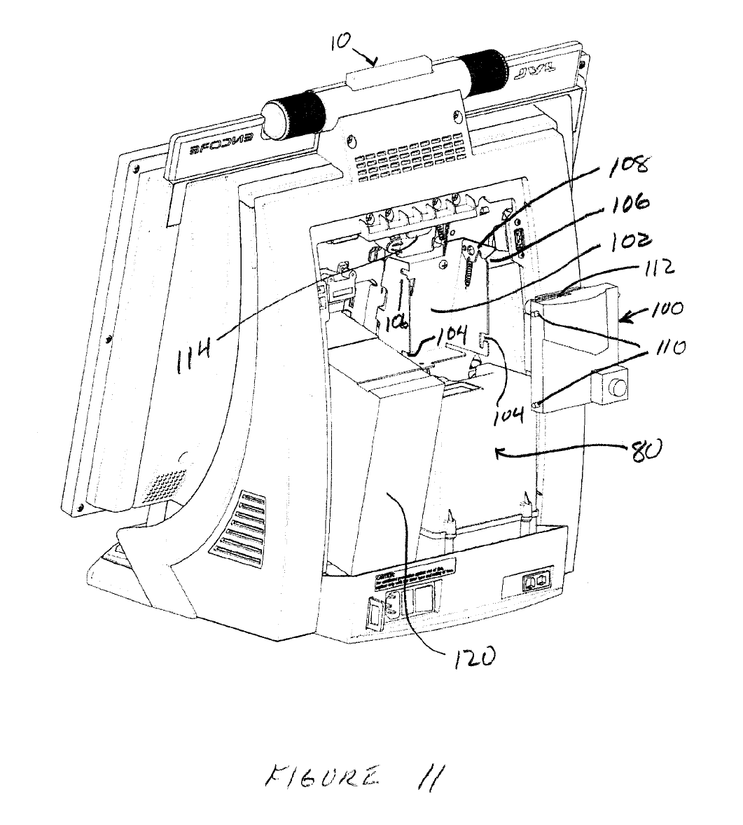

Details of the coin box, the coin acceptor and the banknote cassette are shown in FIGS. 8 through 11. The entertainment terminal includes the coin box 80 having a coin slot 82 and an upper surface of the coin box that receives coins inserted through the coin slot 10 after they are accepted by the coin acceptor 100. Accepted coins are captured within the coin box, and eventually coins within the coin box are collected by removing the coin box and dumping the coins by removing the plug portion 92.

The coin box 80 includes a base portion 84 having a support surface 88. A front edge of the coin box is notched as shown at 86 to allow for air flow through the power supply. This aspect is shown in FIG. 8, where the coin box 80 is about to be inserted for support on surface 90 of the power supply. The notched portion overlies the grates of the power supply and thereby allows air to circulate through the power supply.

The coin acceptor 100 is releasably secured within the game terminal by engagement with the support bracket 102. The bracket 102 includes bottom support slots 104 and upper slots 106. The acceptor 100 includes securing pins 110 provided on the sides of the coin acceptor and the bottom pins are first inserted into slots 104, basically captured in the support bracket, and the coin acceptor is then pivoted forward and located within the slots 106. This action causes the spring latch 108 to be biased upwardly and then capture and retain one of the pins 110. This simplifies the securement and release of the coin acceptor within the device. With the coin acceptor properly positioned, coins enter the coin acceptor through slot 112 and pass out the bottom of the coin acceptor for entry in the coin slot 82 of the coin box. Coins are initially provided to the coin acceptor through a coin channel provided within an upper portion of the game terminal 2. Coins are inserted through coin slot 10 and pass out the discharge slot 114 for entry into the coin acceptor 100. The tweeter speaker subassembly partially defines a coin slot passage.

The banknote cassette 120 is inserted into the terminal from the back thereof and cooperates with the banknote input slot 12. Basically, the banknote input slot 12 includes a validator to confirm the validity of the banknotes, and valid banknotes are then stored in the banknote cassette 120. If a banknote is not acceptable, it is returned through the banknote input slot 12.

It has been found that the entertainment terminal 2 provides the additional capabilities of a high quality stereo sound system that enhances both the play associated with games of the entertainment terminal. The terminal also provides high quality reproduction of sound recordings that may be provided to the entertainment terminal. The countertop design accommodates an effective sub-woofer speaker that has not been previously possible in such countertop terminals. The sub-assembly of the stereo sound system allows for high durability as well as ease of replacement should any of the sub-assemblies require attention.

The countertop entertainment terminal preferably uses a 22 inch touch screen and can be placed on a countertop in a space approximately 24 inches by 20 inches.

Although various preferred embodiments of the present invention have been described herein in detail, it will be appreciated by those skilled in the art, that variations may be made thereto without departing from the spirit of the invention or the scope of the appended claims.

The embodiments of the invention in which an exclusive property or privilege is claimed are defined as follows:

1. A countertop entertainment terminal comprising a terminal housing containing therein a power supply, a CPU, a payment acceptor, a host of games stored in memory and accessible for play, and a stereo sound system; said housing supporting a touchscreen to one side of said housing and having a game input control pad in front of and below said touchscreen; said housing supporting two tweeter speakers adjacent an upper edge of said terminal housing and a pair of midrange speakers located on opposite sides of said housing and adjacent said touchscreen; said terminal further including a sub-woofer speaker interior to said terminal housing and associated with a speaker grating provided on a side of said terminal housing.

2. An entertainment terminal as claimed in claim 1 wherein said touchscreen monitor is pivotally secured to said terminal housing adjacent a bottom edge of said touchscreen for pivotal movement between a in use position with said touchscreen monitor closing a large service port in a front surface of said terminal housing to a service position opening said large service port to provide access to the interior of said terminal housing.

3. An entertainment terminal as claimed in claim 1 wherein said tweeter speakers are supported in a tweeter speaker subassembly, said tweeter speaker subassembly having one of said tweeter speakers supported at one end of said subassembly with the other tweeter speaker supported at an opposite end of said subassembly.

4. An entertainment terminal as claimed in claim 3 wherein said tweeter subassembly is mounted to an upper edge of said terminal housing and extends above and is generally parallel to said upper edge of the terminal housing.

5. An entertainment terminal as claimed in claim 4 wherein said midrange speakers are mounted in a midrange subassembly to position said midrange speakers either side of and adjacent a lower edge of said touchscreen monitor; said midrange subassembly forming part of said terminal housing.

6. An entertainment terminal as claimed in claim 5 wherein said midrange subassembly includes a speaker housing for each midrange speaker with each speaker housing being removable from said subassembly if required for speaker repair or replacement.

7. An entertainment terminal as claimed in claim 6 wherein said sub woofer speaker is secured in a sub woofer subassembly secured within said terminal housing.
